(19) United States
(12) Patent Application Publication
(10) Pub. No.: US 2009/0071309 A1
(43) Pub. Date: Mar. 19, 2009

(54) Structure Of Low Noise Saw And Low Noise Diamond Saw

(75) Inventors: Kwang-Koo Jee, Seoul (KR); Jun-Hyun Han, Seoul (KR); Yoon-Bae Kim, Seoul (KR); Seung-Hee Han, Seoul (KR)

Correspondence Address: OSTROLENK FABER GERB & SOFFEN, 1180 AVENUE OF THE AMERICAS, NEW YORK, NY, 100368403, US

(73) Assignee: Korea Institution of Science and Technology, Seoul (KR)

(21) Appl. No.: 11/994,388

(22) PCT Filed: Dec. 6, 2006
(86) PCT No.: PCT/KR2006/005223

§ 371 Date: Jul. 16, 2008

(30) Foreign Application Priority Data
Jan. 4, 2006 (KR) 10-2006-0001093
Apr. 11, 2006 (KR) 10-2006-0032971
Nov. 8, 2006 (KR) 10-2006-0110157

(51) Int. Cl. B23D 61/00; B28D 1/04; B27B 33/08; B23D 61/02

(52) U.S. Cl. 83/664; 83/835; 83/676; 125/15; 125/39; 83/697

(57) ABSTRACT

Disclosed is a diamond saw capable of reducing noise by installing a damper for absorbing vibration in a shank. The low noise diamond saw comprises: a shank formed of a circular metallic plate; and a diamond blade bonded to an outer circumferential surface of the shank, in which a damper is partially bonded to one or both of upper and lower surfaces of the shank by a spot welding. Said one or both of the upper and lower surfaces of the shank may be provided with recesses having a thickness enough for an uppermost portion of the damper not to be higher than an uppermost portion of the diamond blade According to another embodiment of the present invention, a low noise diamond saw comprises: a shank formed of a circular metallic plate; and a diamond blade bonded to an outer circumferential surface of the shank, in which a plurality of recesses having a predetermined depth are formed in upper and lower surfaces of the shank in correspondence with each other in a circumferential direction, a hole having a diameter smaller than that of the recess is formed in the recess, and a damper is mounted in the hole so that a clearance may not be generated between a surface of the recess and a surface of the damper. In the diamond saw, noise is reduced as the number of the dampers is increased.

### TECHNICAL FIELD

The present invention relates to a structure of a low noise saw, and more particularly, to a diamond saw and a saw for cutting wood, metal, etc. capable of reducing noise occurred at the time of a cutting operation.

### BACKGROUND ART

As shown in FIG. 1, a diamond saw for cutting rock, concrete, asphalt, etc. under the construction for a building or a road comprises diamond blades bonded onto an outer circumference of a disc-shaped shank formed of a cold-rolled carbon steel.

When rocks or concretes are cut by the diamond saw, severe noise is generated due to vibration of the shank. Accordingly, it is being mandatory to use a low noise diamond saw in Korea. In the developed countries, it has been generalized to use the low noise diamond saw on the construction spot.

As shown in FIG. 2, the shank of the low noise diamond saw has a sandwich-type structure, in which a thin copper plate is interposed between two carbon steel plates and then is spot-welded. Accordingly, vibration generated due to interference or friction between the plates is absorbed thus the noise is reduced.

The sandwich-type shank is more expensive than a general shank of a carbon steel by more than four times, and its application is restricted by relatively low rigidity.

Furthermore, the sandwich-type shank cannot be applied to a large sa w having a diameter of approximately 1 meter.

The Korean Open-Laid Patent Publication No. 2000-0067474 has disclosed a method for reducing noise of saw by preventing vibration with using a damper having a similar shape to a rivet. The damper is provided with an object that moves by vibration. The object collides with a metallic plate thus to_generate a frictional force, thereby preventing vibration of the metallic plate. To this end, the damper has to have a mass greater than that of the metallic plate. However, if the damper has a great mass, an entire mass of the saw is increased. Furthermore, the metallic plate may be cracked at the time of the collision and friction with the damper due to a clearance therebetween. Accordingly, the metallic plate has a short lifespan, and a cutting depth is limited since the damper has a thickness thicker than that of the saw.

### DISCLOSURE OF THE INVENTION

Therefore, it is an object of the present invention to provide a structure of a low noise saw capable of enhancing a vibration absorbing capability, preventing an intensity lowering, facilitating a processing, and being applicable to a large saw. Also, there is provided a diamond saw for cutting rock, and a low noise saw for cutting wood, metal, etc.

### BRIEF DESCRIPTION OF THE DRAWINGS

FIG. 1 is a plane view showing a diamond saw for cutting rock in accordance with the conventional art;

FIG. 2 is a plane view showing a sandwich typed diamond saw in accordance with the conventional art;

FIG. 3 is a sectional view showing a vibration absorbing principle of a low noise saw according to the present invention;

FIG. 4 is a view showing a vibration absorbing capability (i.e., specific damping capacity) according to a clearance;

FIGS. 5 to 7 are sectional views showing a shank having a damper according to the present invention, in which

FIG. 5 shows a shank to which a damper of a rivet form is mounted;

FIG. 6 shows a shank having a damper bonded to upper and lower surfaces of the shank; and

FIG. 7 shows a shank having a damper bonded only to one surface of the shank;

FIG. 8 is a sectional view showing a shank having a limited cut depth;

FIGS. 9 to 11 are sectional views showing shanks having unlimited cut depths, in which

FIG. 9 shows a shank having a damper of a rivet form is mounted;

FIG. 10 shows a shank having a damper bonded to upper and lower surfaces of the shank; and

FIG. 11 shows a shank having a damper bonded only to one surface of the shank;

FIG. 12 is a plane view showing a diamond saw to which a damper is mounted according to the present invention;

FIG. 13 is a sectional view of the diamond saw of FIG. 7A for noise test;

FIG. 14 is a view showing a specific damping capacity according to a thickness of a plate;

FIG. 15 is a sectional view of a plate for testing a specific damping capacity according to a thickness of a plate; and

FIG. 16 is a plane view showing a reciprocating saw for cutting wood, etc. according to another embodiment of the present invention.

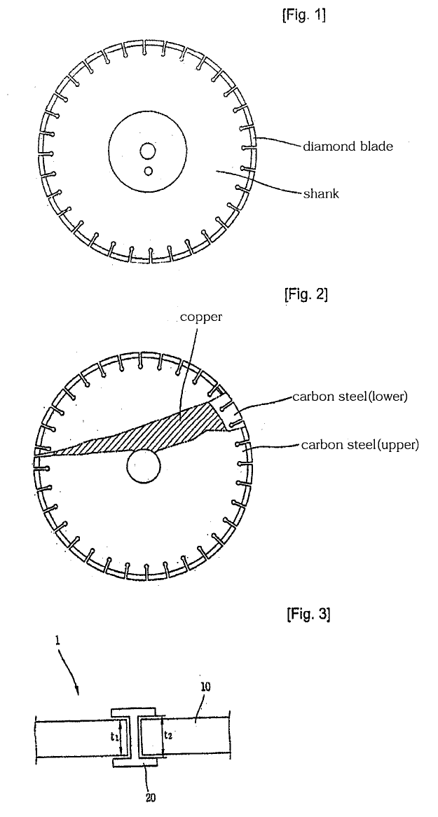

### MODES FOR CARRYING OUT THE PREFERRED EMBODIMENTS

The present invention provides a saw structure capable of reducing noise occurred at the time of a cutting operation by installing a damper on a part of a shank.

FIG. 3 is a sectional view showing a vibration absorbing principle of a low noise saw 1 according to the present invention. A hole is formed in a metallic plate 10, and a damper 20 of a rivet form is inserted into the hole. Herein, a vibration absorbing capability becomes different according to a relation between a thickness (t₁) of the metallic plate contacting the damper and an inner interval (t₂) of the damper.

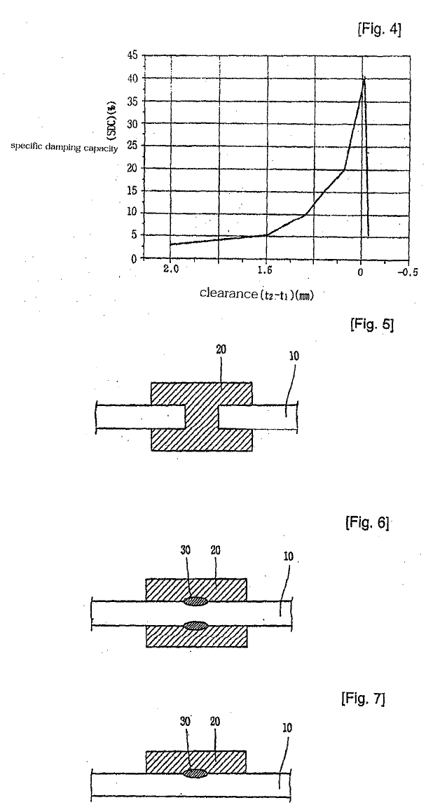

In the present invention, a damper of a rivet form (a head thickness of 2 mm, a diameter of 15 mm) is installed at a metallic plate (a thickness of 2 mm, a horizontal length of 100 mm, and a vertical length of 100 mm), and a vibration absorbing capability is measured according to a clearance (t₂-t₁). The vibration absorbing capability is shown as a specific damping capacity (SDC) in FIG. 4, that is, a ratio of vibration energy absorbed in one cycle. As shown in FIG. 4, when the clearance is approximately 2 mm, the SDC is approximately 3%. As the clearance is decreased, the SDC is increased. When the clearance is ‘0’, the SDC is maximized as approximately 40%. However, when the clearance becomes a negative number (the metallic plate is a little deformed by a compression), the SDC is drastically decreased. A precise value of the negative number of the clearance can be obtained by tightening a point where the clearance is ‘0’ with using a screw. A sum of vibration amplitude and the t₁ is not greater than the t₂. Accordingly, when the t₁ is equal to the t₂, it is considered that vibration scarcely occurs and the occurred vibration is quickly absorbed. However, if a value obtained by deducting t₁ from the t₂ (t₂−t₁) is a negative number, the damper is completely bonded to the metallic plate as one body. The damper vibrates together with the metallic plate, thereby not being able to absorbing vibration from the metallic plate.

That is, in order for the damper to absorb vibration occurred from the metallic plate at the time of a cutting operation with a maximum state, the clearance of the metallic plate has to be minimized.

To this end, a hole is formed at the metallic plate and a damper of a rivet form is installed at the hole (FIG. 5). A damper is partially bonded to both surfaces of the metallic plate (FIG. 6), or to one surface of the metallic plate (FIG. 7). In FIGS. 6 and 7, the damper may be bonded to the metallic plate by a spot-welding.

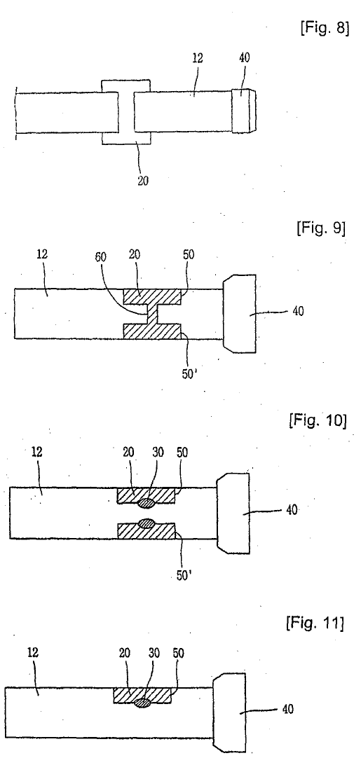

There is a problem in applying the damper of a rivet form to the shank due to the following reasons. As shown in FIG. 8, a diamond blade 40 generally has a thickness thicker than that of a shank 12. When the damper is installed at the shank, an entire thickness of the shank becomes thicker than that of the diamond blade. Accordingly, a cutting depth is limited to the position of the damper, and the damper is protruding outside the saw thus to damage an appearance.

In the present invention, the structure of the shank was modified. As shown in FIGS. 9 to 11, a thickness of the shank 12 is decreased at a position where the damper 20 is inserted, thereby solving the conventional problem. In FIGS. 9 to 11, recesses 50 and 50′ for receiving the damper have a depth so that an uppermost portion of the damper may be lower than an uppermost portion of the diamond blade.

According to present invention, a large saw having a diameter more than 1 meter has a thick thickness, thereby facilitating to obtain a damper installation region inside the shank. Furthermore, since the diamond blade has a thickness thicker than that of the shank, the damper is more easily installed.

A low noise diamond saw according to one embodiment of the present invention comprises: a shank formed of a circular metallic plate; and a diamond blade bonded to an outer circumferential surface of the shank, in which a damper is partially bonded to one or both of upper and lower surfaces of the shank by a spot welding.

Said one or both of the upper and lower surfaces of the shank may be provided with recesses 50 and 50′ having a thickness enough for an uppermost portion of the damper not to be higher than an uppermost portion of the diamond blade. The recesses may be formed to be concentric from each other, or to be eccentric from each other.

According to another embodiment of the present invention, a low noise diamond saw comprises: a shank formed of a circular metallic plate; and a diamond blade bonded to an outer circumferential surface of the shank, in which a plurality of recesses 50 and 50′ having a predetermined depth are formed in upper and lower surfaces of the shank in correspondence with each other in a circumferential direction, a hole 60 having a diameter smaller than that of the recess is formed in the recess, and a damper is mounted in the hole so that a clearance may not be generated between a surface of the recess and a surface of the damper.

According to still another embodiment of the present invention, a low noise reciprocating saw for cutting wood, metal, etc. comprises: a shank formed of a rectangular metallic plate; and saw blades formed along long edges of the shank, in which a damper is partially bonded to one or both of upper and lower surfaces of the shank by a spot welding.

Said one or both of the upper and lower surfaces of the shank may be provided with recesses 50 and 50′ having a thickness enough for an uppermost portion of the damper not to be higher than an uppermost portion of the saw. The recesses may be formed to be concentric from each other, or to be eccentric from each other.

According to yet still another embodiment of the present invention, a low noise reciprocating saw comprises: a shank formed of a rectangular metallic plate; and saw blades formed along long edges of the shank, in which a plurality of recesses having a predetermined depth are formed in upper and lower surfaces of the shank in correspondence with each other along long edges of the shank, a hole having a diameter smaller than that of the recess is formed in the recess, and a damper is mounted in the hole so that a clearance may not be generated between a surface of the recess and a surface of the damper.

The damper has a rivet form, and is formed of a high damping alloy having an excellent noise reducing function. The high damping alloy may include an Fe—Cr—Al alloy, an Fe—Al—Si alloy, an Fe—C—Si alloy, an Mg-based alloy, an Mn—Cu alloy, a Cu—Al—Ni alloy, an Ni—Ti alloy, an Fe—Mn alloy, etc.

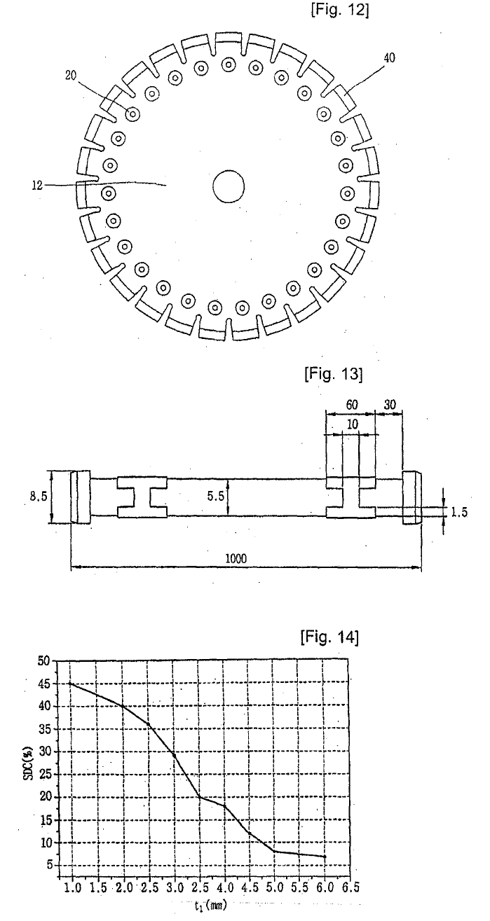

FIG. 12 is a plane view showing a diamond saw, in which dampers of a rivet form are mounted on a shank having a diameter of 1000 mm and a thickness of 5.5 mm in a circumferential direction. Noise of the diamond saw according to the number of dampers is shown in the following table 1. Herein, a clearance of the damper and the shank was set to be ‘0’ mm.

TABLE 1

The number of dampers

| | 0 | 6 | 12 | 18 |
|---|---|---|---|---|
| Noise (dB) | 113.6 | 106.4 | 102.5 | 98.5 |

As shown in the table 1, the noise when the 18 dampers are installed is less than the noise when no damper is installed by 15 dB.

A test for a specific damping capacity according to a thickness of a plate was performed in the same condition as the condition shown in FIGS. 3 and 4. Herein, a clearance between the metallic plate and the damper of a rivet form was set to be ‘0’, that is, t₁=t₂, and only the thickness of the metallic plate (t₁) was changed. A result of the test was shown in FIG. 14. As shown in FIG. 14, the more the thickness of the metallic plate is increased, the more the specific damping capacity is decreased. When the thickness of the metallic plate is increased, a vibration amplitude is reduced thus to degrade an interference.

In order to increase the specific damping capacity when a thick metallic plate is used, as shown in FIG. 15, a rivet is installed at the metallic plate having a recess for receiving the damper of a rivet form. As shown in FIG. 14, if a recess having a thickness (t₂) of 2.5 mm is formed at the metallic plate having a thickness (t₁) of 4.5 mm and a damper of a rivet form is installed at the metallic plate, the specific damping capacity (SDC) is increased to 31% from 12% when no recess is formed at the metallic plate. Also, if a recess having a thickness (t₂) of 4.0 mm is formed at the metallic plate having a thickness (t₁) of 6.0 mm and then a damper of a rivet form is installed at the metallic plate, the specific damping capacity (SDC) is increased to 15% from 7% when no recess is formed at the metallic plate. As the damper of a rivet form is not exposed outside the metallic plate, the structure is effectively applied to a thick saw.

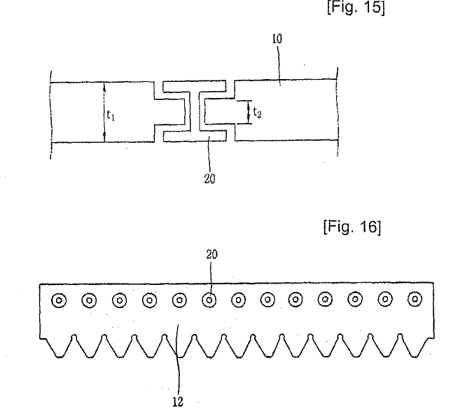

FIG. 16 is a plane view showing a reciprocating saw for cutting wood, metal, etc. according to another embodiment of the present invention, in which noise decrease according to a damper installation is similar to that of the diamond saw shown in the table 1.

The present invention has the following effects.

First, since the damper is bonded to the saw by a spot-welding, noise occurred at the time of a cutting operation is remarkably reduced.

Second, the spot-welding method facilitates mounting of the damper and an automatic production line.

Third, since a hole is not formed in the metallic plate, crack due to a processing of the hole is not caused thus to enhance durability of the saw.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A structure of a low noise saw, comprising:
a shank formed of a metallic plate; and
saw blades formed along an outer circumferential surface of the shank, in which a damper is partially bonded to one or both of upper and lower surfaces of the shank by a spot welding.

2. The structure of claim 1, wherein a recess having a predetermined thickness for receiving the damper is formed at one or both of the upper and lower surfaces of the shank.

3. A structure of a low noise saw, comprising:
a shank formed of a metallic plate; and
saw blades formed along an outer circumferential surface of the shank, in which a plurality of recesses having a predetermined depth are formed in upper and lower surfaces of the shank in correspondence with each other, a hole having a diameter smaller than that of the recess is formed in the recess, and a damper is mounted in the hole so that a clearance of 2 mm or less than may be formed between a surface of the recess and a surface of the damper.

4. The structure of claim 3, wherein a damper is mounted in the hole so that a clearance may not be formed between a surface of the recess and a surface of the damper.

5. The structure of one of claims 1 to 4, wherein the damper has a rivet form.

6. The structure of claim 5, wherein the damper is formed of a high damping alloy.

7. A low noise diamond saw, comprising:
a shank formed of a circular metallic plate; and
a diamond blade bonded to an outer circumferential surface of the shank, in which a damper is partially bonded to one or both of upper and lower surfaces of the shank by a spot welding.

8. The low noise diamond saw of claim 7, wherein a recess having a predetermined thickness for receiving the damper is formed at one or both of the upper and lower surfaces of the shank.

9. A low noise diamond saw, comprising:
a shank formed of a circular metallic plate; and
a diamond blade bonded to an outer circumferential surface of the shank, in which a plurality of recesses having a predetermined depth are formed in upper and lower surfaces of the shank in correspondence with each other in a circumferential direction, a hole having a diameter smaller than that of the recess is formed in the recess, and a damper is mounted in the hole so that a clearance of 2 mm or less than may be formed between a surface of the recess and a surface of the damper.

10. The low noise diamond saw of claim 9, wherein the damper is mounted so that a clearance may not be formed between a surface of the recess and a surface of the damper.

11. The low noise diamond saw of one of claims 7 to 10, wherein the damper has a rivet form.

12. The low noise diamond saw of 11, wherein the damper is formed of a high damping alloy.

13. A low noise reciprocating saw, comprising:
a shank formed of a rectangular metallic plate; and
saw blades formed along long edges of the shank, in which a damper is partially bonded to one or both of upper and lower surfaces of the shank by a spot welding.

14. A low noise reciprocating saw of claim 13, wherein a recess having a predetermined thickness for receiving the damper is formed at one or both of the upper and lower surfaces of the shank.

15. A low noise reciprocating saw, comprising:
a shank formed of a rectangular metallic plate; and
saw blades formed along long edges of the shank, in which a plurality of recesses having a predetermined depth are formed in upper and lower surfaces of the shank in correspondence with each other along long edges of the shank, a hole having a diameter smaller than that of the recess is formed in the recess, and a damper is mounted in the hole so that a clearance of 2 mm or less than may be generated between a surface of the recess and a surface of the damper.

16. The low noise reciprocating saw of claim 15, wherein the damper is mounted in the hole so that a clearance may not be generated between a surface of the recess and a surface of the damper.

17. The reciprocating saw of one of claims 13 to 16, wherein the damper has a rivet form.

18. The low noise reciprocating saw of 17, wherein the damper is formed of a high damping alloy.
